(19) United States
(12) Patent Application Publication
(10) Pub. No.: US 2022/0348127 A1
(43) Pub. Date: Nov. 3, 2022

(54) LOADING ATTACHMENT FOR VEHICLE

(71) Applicant: David Roger Kauffman, Clarksville, MI (US)

(72) Inventor: David Roger Kauffman, Clarksville, MI (US)

(21) Appl. No.: 17/658,272

(22) Filed: Apr. 7, 2022

Related U.S. Application Data
(60) Provisional application No. 63/182,052, filed on Apr. 30, 2021.

(51) Int. Cl. B60P 1/54; B60P 1/48

(52) U.S. Cl. CPC B60P 1/5485; B60P 1/483

(57) ABSTRACT

A sideboard loading attachment for a utility vehicle includes a pair of lift arms coupled to box sides of the vehicle, a crossbar extending between distal ends of the projection arms, and a pair of lift actuators for raising and lowering the lift arms, whose distal ends can extend rearwardly from the vehicle when fully extended. A cable hoist is coupled to the utility vehicle and has a cable reeved over a pulley at the crossbar. The cable hoist raises and lowers the cable at the crossbar, and the lift actuators actuate the lift arms to raise a load up forwardly over the box of the utility vehicle.

### FIELD OF THE INVENTION

The present invention is directed to a loading and lift system for a utility vehicle.

### BACKGROUND OF THE INVENTION

Utility vehicles such as dump trucks are commonly used to haul static bulk material. Such vehicles often have sideboard extensions to increase cube/load capacity. Bulky objects such as machinery or logs can be loaded using forklifts, hoists, or loaders, but such devices are typically costly, may be complicated to use, or are not necessarily available in every location where it is desirable to lift large of heavy objects into the box of the utility vehicle. Lastly, tailgates on these vehicles are usually too heavy to open and close by hand.

### SUMMARY OF THE INVENTION

The present invention uses sideboards that act as pivotable lift arms in combination with a cable hoist to raise and lower objects from outside the vehicle to the box of the vehicle, and vice versa. The sideboard lift arms are coupled to the top of the box sides and have a crossbar extending between distal ends of the sideboard lift arms. A pair of lift actuators raise and lower the arms so that their ends extend rearwardly from the vehicle. The cable hoist is typically fixed to the forward end of the box, and has a cable reeved over the pulley at the crossbar. The cable hoist raises and lowers the cable at the crossbar, and the lift actuators actuate the lift arms to raise a load up and forwardly over the box of the utility vehicle.

These and other objects, advantages, purposes and features of this invention will become apparent upon review of the following specification in conjunction with the drawings.

### BRIEF DESCRIPTION OF THE DRAWINGS

FIG. 1 is a rear perspective view of a sideboard loading attachment in accordance with the present invention, shown fitted to a utility vehicle and in a partially extended position;

FIG. 2 is a left side perspective view of the sideboard loading attachment and vehicle of FIG. 1, with the sideboard loading attachment in a further extended position;

FIG. 3 is a left side perspective view of the sideboard loading attachment of FIG. 1;

FIG. 4 is a left side perspective view of the sideboard loading attachment in a fully lowered or retracted position;

FIG. 5 is a right side perspective view of the sideboard loading attachment shown fitted to another utility vehicle and in the fully lowered or retracted position;

FIG. 6 is another right side perspective view of the sideboard loading attachment and vehicle of FIG. 5, shown with a rear tailgate of the vehicle in a partially lowered position and held by a hoist cable of the sideboard loading attachment;

FIG. 7 is a rear perspective view of the sideboard loading attachment and vehicle of FIG. 5, shown with the rear tailgate lowered and the sideboard loading attachment partially raised;

FIG. 8 is another rear perspective view of the sideboard loading attachment and vehicle of FIG. 5, shown with the sideboard loading attachment raised to a vertical position;

FIG. 9 is a right side perspective view of the sideboard loading attachment and vehicle of FIG. 5, shown with the sideboard loading attachment fully extended to a rearward position;

FIG. 10 is an enlarged rear perspective view of a bed region of the vehicle and the sideboard loading attachment in the partially raised position;

FIG. 11 is an enlarged left side perspective view of a forward region of the vehicle bed region and sideboard loading attachment;

FIG. 12 is another rear perspective view of the sideboard loading attachment and vehicle of FIG. 5, shown with the sideboard loading attachment fully extended to the rearward position;

FIG. 13 is an enlarged left side perspective view of the bed portion of the vehicle and a portion of the sideboard loading attachment of FIG. 12;

FIG. 14 is a rear perspective view of a left side portion of the vehicle and sideboard loading attachment in the lowered or retracted position;

FIG. 15A is a rear perspective view of the vehicle and sideboard loading attachment in a raised position, and with a cable of the sideboard loading attachment connected to a log section;

FIG. 15B is a left side perspective view of the vehicle and sideboard loading attachment of FIG. 15A, with the sideboard loading attachment extended to the rearward position and shown lifting the log section;

FIG. 15C is a left side perspective view of the vehicle and sideboard loading attachment of FIG. 15A, with the sideboard loading attachment partially raised from the rearward position and shown lifting the log section upwardly and forwardly toward the lowered tailgate of the vehicle;

FIG. 15D is a left-rear perspective view of the vehicle and sideboard loading attachment of FIG. 15A, with the sideboard loading attachment moved further toward the lowered or retracted position and suspending the log over the bed of the vehicle; and

### DESCRIPTION OF THE PREFERRED EMBODIMENTS

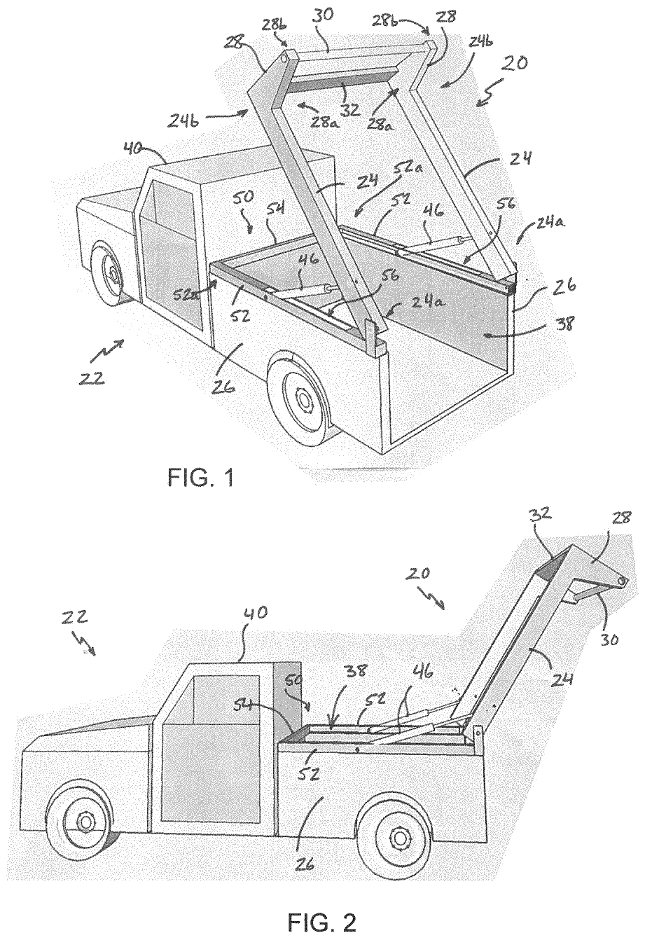

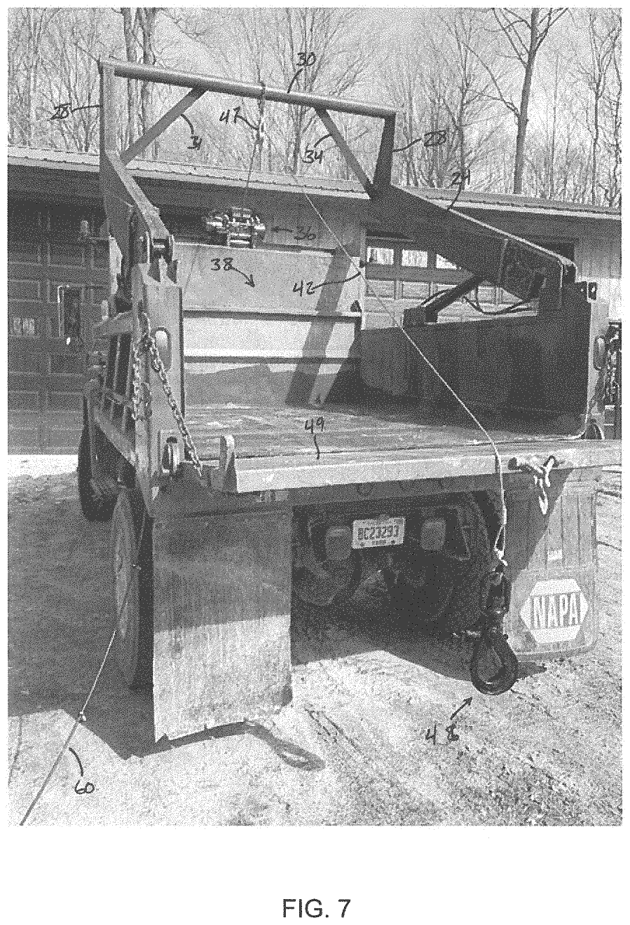

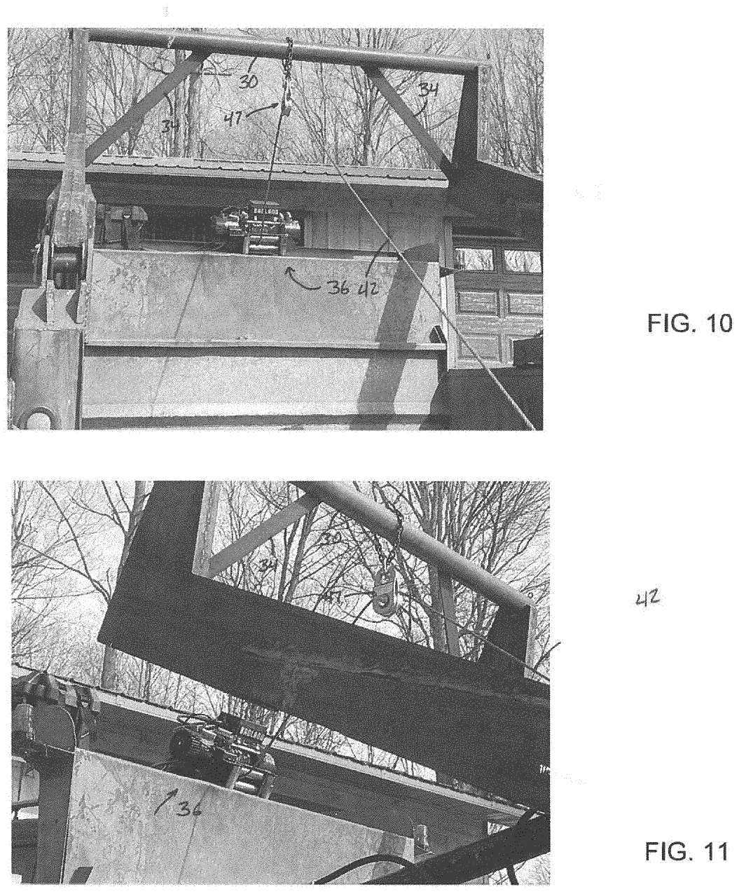

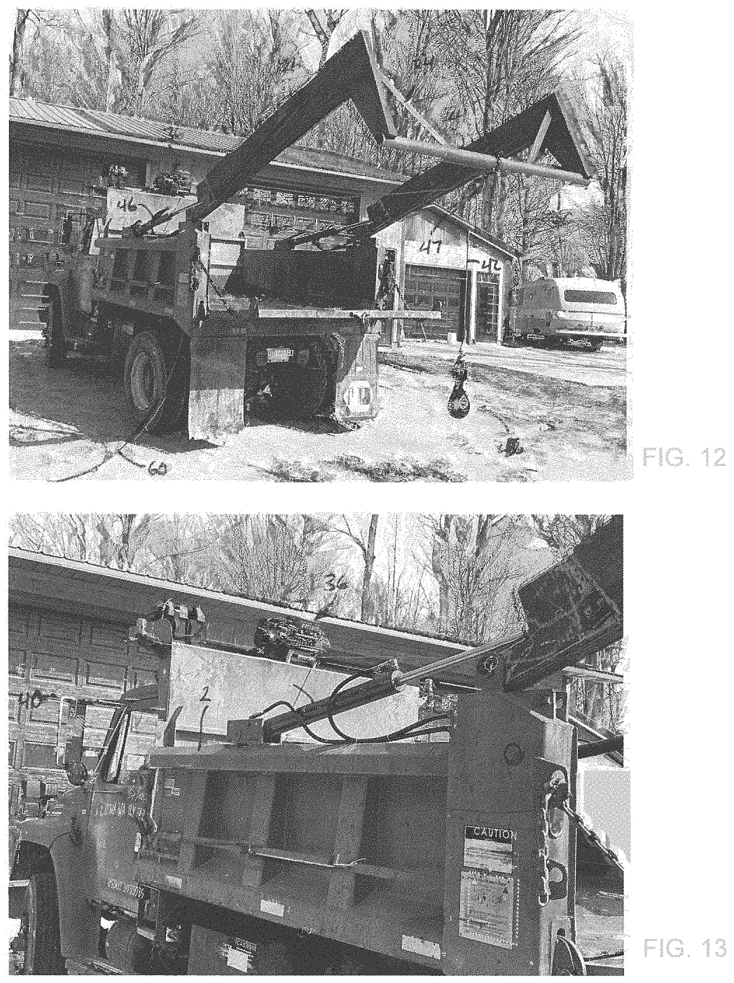

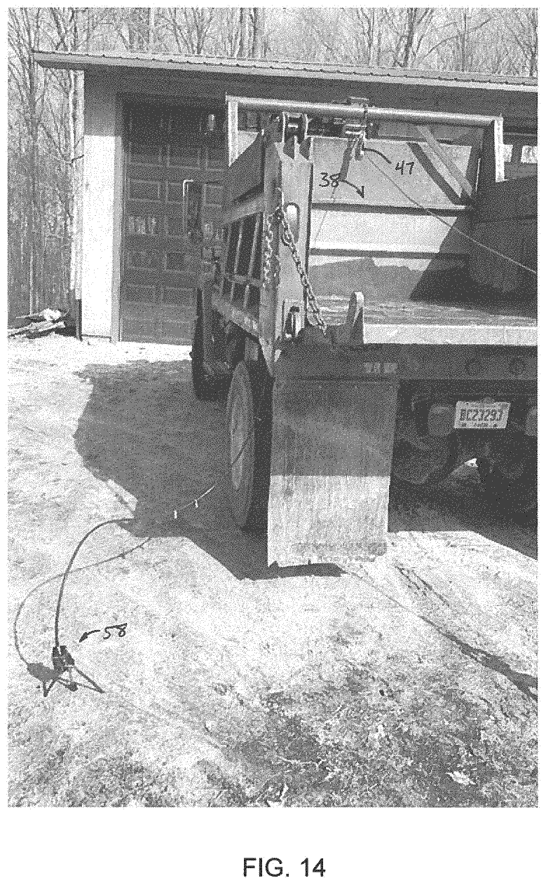

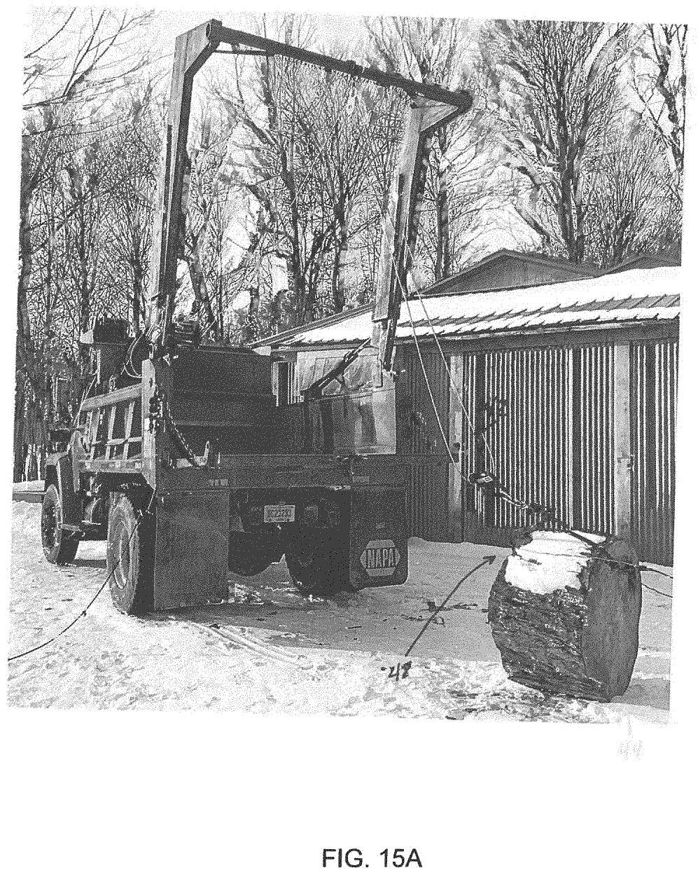

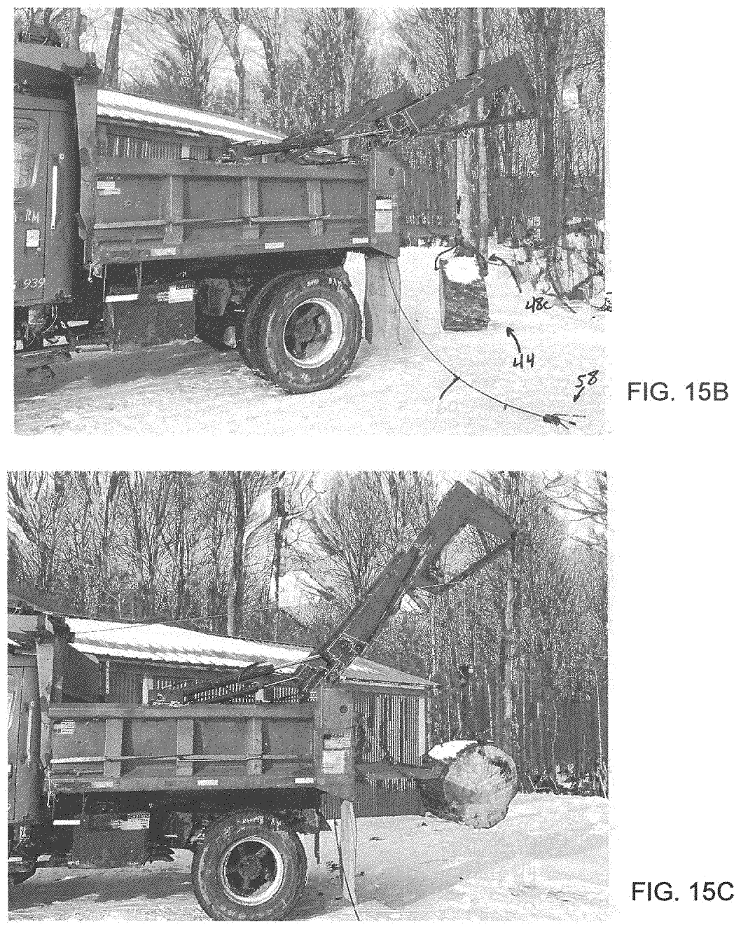

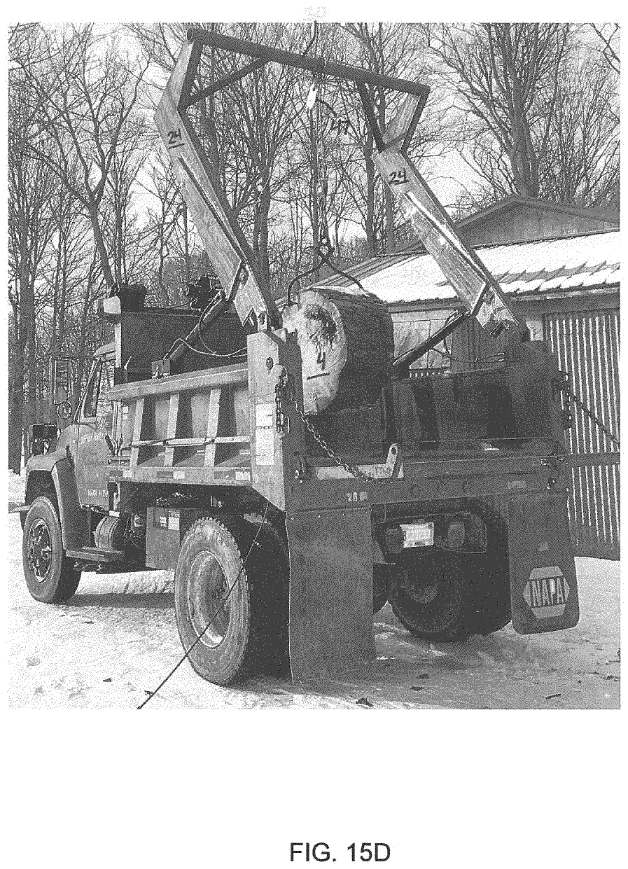

Referring now to the drawings and the illustrative embodiments depicted therein, a sideboard loading attachment 20 for a utility vehicle 22 includes a pair of longitudinally-extending lift arms 24 having proximal ends 24a that pivotably couple to box sides 26 of the vehicle 22, such as shown in FIGS. 1 and 2. A pair of upwardly-extending projection arms 28 have proximal ends 28a coupled to distal ends 24b of the lift arms 24, and a crossbar 30 extends between distal ends 28b of the projection arms 28. Optionally, an extra crossbar 32 extends between distal ends 24b of lift arms 24 (FIGS. 1-4) or a pair of diagonal braces 34 extend from distal ends 24b to crossbar 30 (FIGS. 7-12) to provide additional rigidity. Referring to FIGS. 7 and 9-15D, a cable hoist 36 is coupled to utility vehicle 22 at a forward end of a bed 38 thereof, proximate the vehicle's cab 40. A cable 42 is extendable and retractable from hoist 36 and is routed to crossbar 30 so that cable 42 can be used to lift an object 44 off of the ground or other support surface behind vehicle 22 and into bed 38 (FIGS. 15A-15D), or unload the object 44 from the bed 38 to the ground or another surface behind vehicle

22. This arrangement does not occupy any space within the vehicle's box 38, is relatively simple, and permits the vehicle 22 equipped with sideboard loading attachment 20 to self-load and self-unload large or heavy objects without need for separate or detachable loading equipment. A single operator can therefore perform heavy loading and unloading operations without assistance, and without bringing or obtaining a separate loading machine such as a forklift.

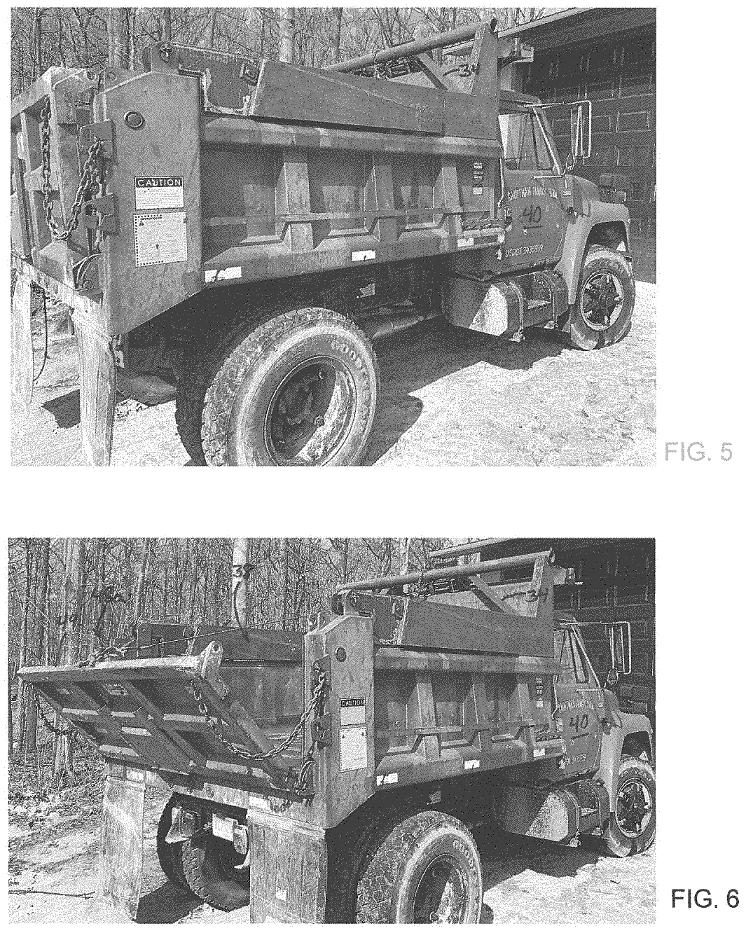

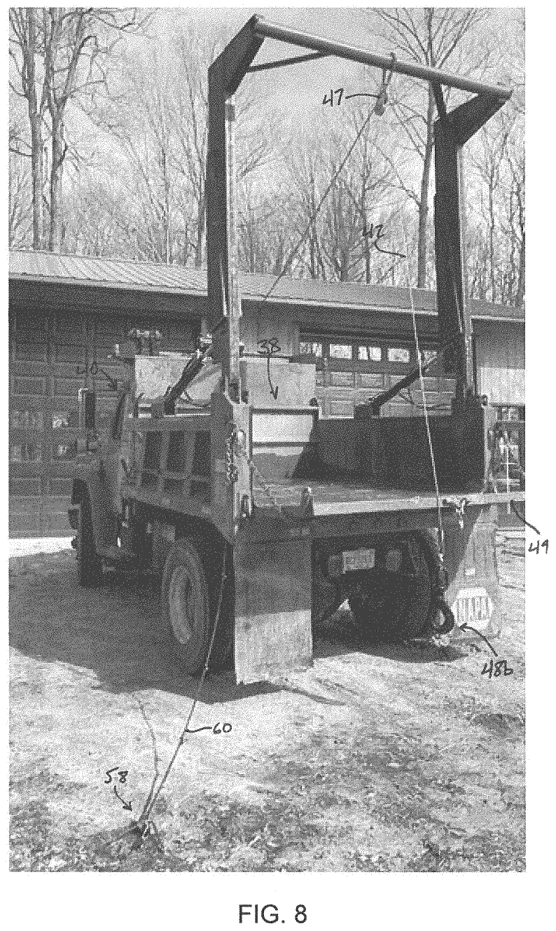

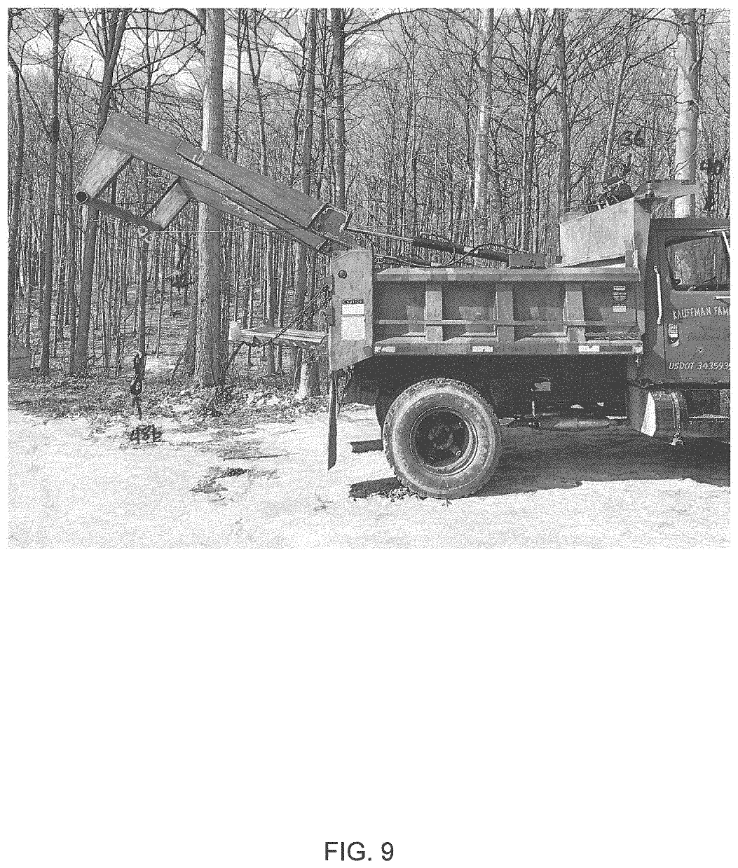

Lift arms 24 are raised by a pair of hydraulic lift actuators 46, from a forward-extending lowered position (FIGS. 4-6 and 14) to an upright position (FIGS. 8 and 15A) to a rearwardly-extending position (FIGS. 9, 12, 13 and 15B) in which the crossbar 30 extends rearwardly of a rear end portion of the utility vehicle 22. During these movements the lift arms 24 pass through a range of intermediate positions where the arms 24 can be stopped if desired. Cable 42 is typically reeved over a pulley 47 at crossbar 30 (FIGS. 7, 8, 10-12, and 14) so that cable hoist 36 can be operated at any position of lift arms 24 to lift and lower objects in the bed 38 or outside the vehicle 22 relative to crossbar 30, and can also be used in a conventional manner to pull objects toward the vehicle, to raise and lower a tailgate 49 of the vehicle (FIG. 6), or even to pull the vehicle toward other objects. By permitting a user to raise and lower the heavy tailgate 49 as shown in 6-8, without requiring a separate piece of lifting equipment, an operator may manually load objects over the lowered tailgate 49 and into bed 38, and then close tailgate 49 using hoist 36 and cable 42.

A distal end of cable 42 may be fitted with various types of hooks 48a, 48b (FIGS. 6-9 and 12), logging tongs 48c (FIGS. 15A-15D) or other accessories as needed. Lift arms 24 may also be raised and lowered with lift actuators 46 to raise and lower objects and reposition them forwardly and rearwardly relative to the vehicle 22, including positioning the load or object 44 in the operator's choice of the rear, mid, or front of the bed 38, with cable hoist 26 operated as needed to maintain desired vertical clearance above objects. In the event that cable 42 is not suitable for lifting or repositioning a desired load or object, crossbar 30 and/or the distal ends 24b of lift arms may be fitted with other attachments such as pallet forks, a loading platform, or the like.

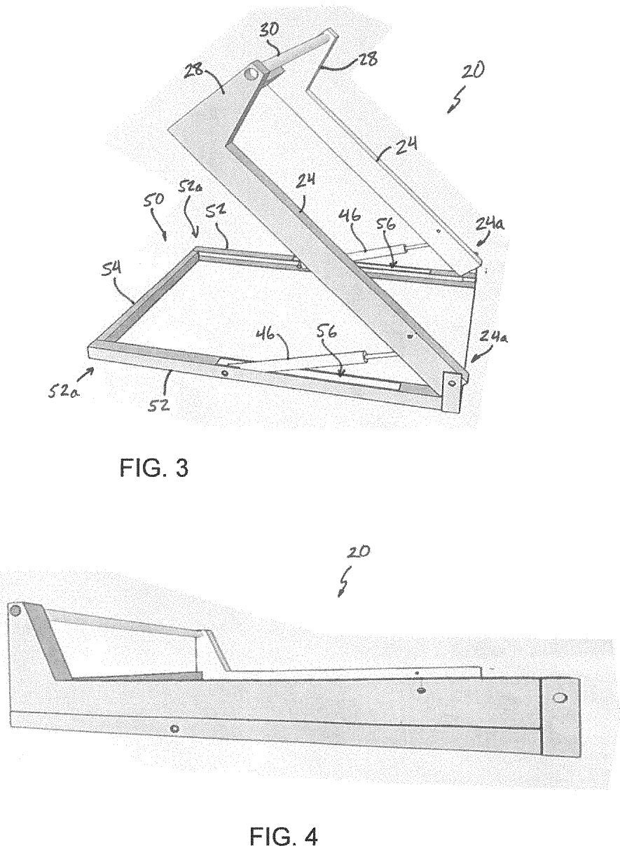

Although lift arms 24 and lift actuators 46 may be coupled directly to box sides 26, a generally U-shaped base frame 50 may be provided for direct coupling to box sides 26 as shown in FIGS. 1 and 2. Base frame 50 includes a pair of longitudinally-extending frame rails 52 and a frame cross beam 54 extending between forward ends 52a of frame rails 52, as shown in FIGS. 1-3. Base frame 50 facilitates one-piece installation and removal of sideboard loading attachment 20 at utility vehicle 22 by providing support for lift arms 24 and with frame rails 52 defining elongate recesses 56 that receive the hydraulic lift actuators 46 when the lift arms 24 are at the forward-extending fully-lowered positions, such as shown in FIGS. 3 and 4. This allows lift arms 24 to lie substantially flush against the frame rails 52 with lift actuators 46 hidden inside recesses 56 of frame rails 52. Alternatively, lift arms 24 may define elongate recesses for receiving the lift actuators 46 to provide substantially the same function, or each of lift arms 24 and frame rails 52 may define partial recesses that receive respective portions of the lift actuators 46. Because lift arms 24 and frame rails 52 are typically positioned directly above box sides 26, the lift arms 24 and frame rails 52 provide protection for box sides 26 from impacts from above, such as may be caused by dropped objects.

Controls for lift actuators 46 and cable hoist 36 may be provided at substantially any convenient location where an operator may remain safe during operation of sideboard loading attachment 20. Cable hoist 36 may be electrically powered and controlled wirelessly from a hand-held wireless remote controller. Optionally, a remote controller 58 (FIGS. 8 and 15B) is provided at the end of a cable 60 so that the operator can stand away from vehicle 22 and the moving parts of sideboard loading attachment 20 during operation, while having a clear view of the load or object 44. Controller 58 may be a handheld joystick controller connected to a 4-way hydraulic valve by cable 60, for controlling fluid flow to the hydraulic lift arms 24. Optionally, control for cable hoist 36 and for lift arms 24 may be provided at a single hand-held unit.

Thus, the sideboard loading attachments of the present invention facilitate the lifting and loading of large, heavy, or bulky loads into the bed or box of a utility vehicle, without impeding the use of the utility vehicle as a dump truck or its other designed functions. The lift arms are effectively upper sideboards of the vehicle when lowered or stowed, and provide a lifting and loading function with the use of a cable or other devices. The sideboard loading attachment can be remotely operated by a single operator who can be positioned a safe distance from the moving parts and the load during operation. The sideboard loading attachment can also be used to raise and lower a tailgate of the vehicle to facilitate manual loading, if desired.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A sideboard loading attachment for a utility vehicle, said sideboard loading attachment comprising:
a pair of longitudinally-extending lift arms having proximal ends configured for pivotably coupling to respective sides of the utility vehicle;
a pair of upwardly-extending projection arms coupled to distal ends of said lift arms;
a crossbar extending between distal ends of said projection arms;
a cable hoist configured for coupling to the utility vehicle, said cable hoist having a cable coupled to said crossbar;
a pair of lift actuators configured to raise said lift arms from a forward-extending lowered position to an upright position, and from the upright position to a rearwardly-extending position in which at least said crossbar extends rearwardly of a rear end portion of the utility vehicle;
wherein said cable hoist is operable to raise and lower said cable at said crossbar with said lift arms in the rearwardly-extending position; and
wherein said lift actuators and said lift arms are operable to raise an object at said cable up and forwardly over a bed of the utility vehicle.

2. The sideboard loading attachment of claim 1, wherein when said longitudinally-extending lift arms are in the retracted position, said lift arms are positioned above the sides of the utility vehicle.

3. The sideboard loading attachment of claim 2, further in combination with said utility vehicle, wherein said proximal ends of said lift arms are positioned at rearward ends of said box sides, and said distal ends of said lift arms are positioned proximate a forward end of the box of said utility vehicle when said lift arms are at said forward-extending lowered position.

4. The sideboard loading attachment of any of claims 1-4, further comprising a pulley at said crossbar, wherein said cable is reeved around said pulley.

5. The sideboard loading attachment of any preceding claim, wherein said lift actuators comprise hydraulic cylinders coupled between the box sides of the vehicle and said lift arms.

6. The sideboard loading attachment of claim 5, further comprising a hand-held remote controller configured to operate said hydraulic cylinders and said cable hoist.

7. The sideboard loading attachment of claim 5, wherein the box sides of the utility vehicle and/or the lift arms define elongate recesses for receiving said hydraulic cylinders when said lift arms are at said forward-extending lowered position, wherein said lift arms lie substantially flush against upper surfaces of the box sides and enclose said hydraulic cylinders in said elongate recesses.

8. The sideboard loading attachment of claim 1, further comprising a U-shaped base frame having a pair of longitudinally-extending frame rails for coupling directly to the respective box sides and a cross beam extending between forward ends of said frame rails.
